(19) United States
(12) Patent Application Publication
(10) Pub. No.: US 2018/0092350 A1
(43) Pub. Date: Apr. 5, 2018

(54) TERNARY AGRICHEMICAL COMPOSITIONS AND RELATED METHODS

(71) Applicant: UNIVERSITY OF CENTRAL FLORIDA RESEARCH FOUNDATION, INC., Orlando, FL (US)

(72) Inventors: Swadeshmukul Santra, Orlando, FL (US); Ziyang Huang, Orlando, FL (US); Parthiban Rajasekaran, Orlando, FL (US); Smruti Das, Orlando, FL (US); Rajneesh Prajapati, Orlando, FL (US)

(73) Assignee: UNIVERSITY OF CENTRAL FLORIDA RESEARCH FOUNDATION, INC., Orlando, FL (US)

(21) Appl. No.: 15/723,598

(22) Filed: Oct. 3, 2017

Related U.S. Application Data
(60) Provisional application No. 62/403,394, filed on Oct. 3, 2016.

(51) Int. Cl. A01N 25/02

(52) U.S. Cl. CPC A01N 25/02; C01B 33/40

(57) ABSTRACT

An agrichemical composition comprises a clay material, a metal chelate material and a quaternary ammonium material. In some instances the agrichemical composition provide superior and synergistic performance in comparison with otherwise analogous agrichemical compositions that do not include at least one of the clay material, the metal chelate material and the quaternary ammonium material.

### CROSS-REFERENCE TO RELATED APPLICATION

This application is related to, and derives priority from, U.S. Provisional Patent Application Ser. No. 62/403,394, filed 3 Oct. 2016 and titled “MS3T—A Clay Laden Antimicrobial and Nutrient Delivery System and Stabilizer,” the contents of which are incorporated herein fully by reference.

### STATEMENT OF GOVERNMENT INTEREST

This invention was made with Government support under Agency contract #2016-70016-24828 awarded by USDA-NIFA. The Government has certain rights in this invention.

### BACKGROUND

### Field

The embodiments relate generally to agrichemicals. More particularly, the embodiments relate to polyfunctional agrichemicals.

### Description of the Related Art

Agrichemicals play an important part in providing a nutritious, abundant and available global food supply that in turn serves to provide, in general, food security for many people. Since changes in global weather patterns and other unpredictable factors may influence global food supply, desirable are agrichemical compositions and methods that assist in providing superior agricultural productivity.

### SUMMARY

The embodiments provide a poly-functional agrichemical composition, and related methods for preparing and using the poly-functional agrichemical composition.

The poly-functional agrichemical composition comprises: (1) a clay material; (2) a metal chelate material; and (3) a quaternary ammonium material. The metal chelate material may be selected from the group consisting of a zinc metal chelate material and a manganese metal chelate material. The agrichemical composition may also further comprise a liquid carrier material such as but not limited to an aqueous liquid carrier material.

The poly-functional agrichemical composition in accordance with the embodiments provides in some aspects superior agrichemical performance in comparison with an otherwise analogous agrichemical composition, but absent at least one of the clay material, the metal chelate material, and the quaternary ammonium material.

A particular agrichemical composition in accordance with the embodiments includes: (1) a clay material; (2) a metal chelate material; and (3) a quaternary ammonium material.

A particular method for preparing a particular agrichemical composition in accordance with the embodiments includes mixing together within a liquid carrier material: (1) a clay material; (2) a metal chelate material; and (3) a quaternary ammonium material.

A particular method for treating a plant with a particular agrichemical composition in accordance with the embodiments includes exposing the plant to a composition comprising: (1) a clay material; (2) a metal chelate material; and (3) a quaternary ammonium material

### BRIEF DESCRIPTION OF THE DRAWINGS

The objects features and advantages of the embodiments are understood within the context of the Detailed Description of the Embodiments, as set forth below. The Detailed Description of the Embodiments is understood within the context of the accompanying drawings, which form a material part of this disclosure, wherein:

FIG. 1 shows the results of phytotoxicity studies in accordance with the embodiments

FIG. 2 shows the results of zinc uptake studies in accordance with the embodiments

FIG. 3 shows the results of antimicrobial studies in accordance with the embodiments.

FIG. 4 shows the results of rain-fastness studies in accordance with the embodiments.

### DETAILED DESCRIPTION OF THE EMBODIMENTS

The embodiments provide an agrichemical composition, a method for preparing the agrichemical composition and a method for treating a plant with the agrichemical composition.

### INCORPORATION BY REFERENCE

Applicant hereby incorporates by reference the following related disclosures into this application.
1. WO 2010/068275—Silica Based Antibacterial and Antifungal Nanoformulation
2. WO 2016/061059—Agrichemical Compositions and Methods of Making and Using Same
3. US 2015/0342194—Non-Phytotoxic Composite Polymer Film Barrier as a Repellant for Controlling Infection

Using the general methodology as taught within the foregoing incorporated references which are directed in general to separate disclosures that evaluate clay materials, chelated zinc materials, and quaternary ammonium materials that are incorporated into agrichemical compositions, applicant has developed a ternary agrichemical composition that includes each of the foregoing materials from the foregoing references that are incorporated by reference.

Applicant provides the following experimental data and information that illustrates in some circumstances the presence of a synergistic effect of the clay material, the metal chelate material, and the quaternary ammonium material within an agrichemical composition in accordance with the embodiments.

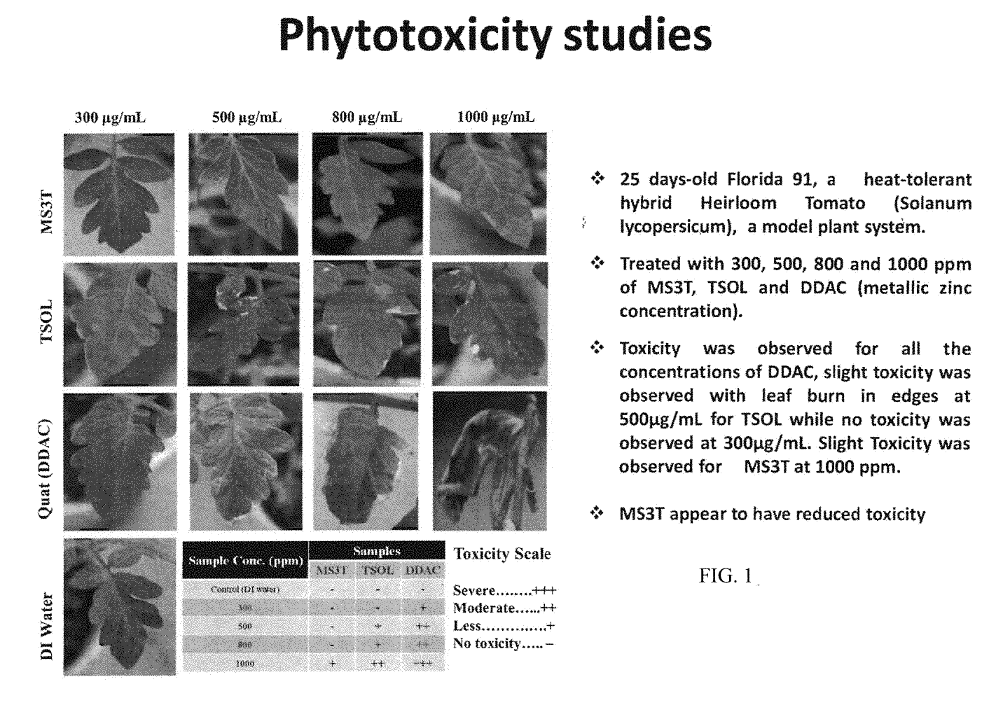

FIG. 1 shows the results of phytotoxicity studies showing comparing MS3T agrichemical composition in comparison with TSOL chelated zinc agrichemical composition only and an equivalent DDAC chelated copper agrichemical composition at the listed treatment levels. As noted on FIG. 1, MS3T agrichemical composition appears to have reduced toxicity in comparison with the TSOL and DDAC agrichemical compositions.

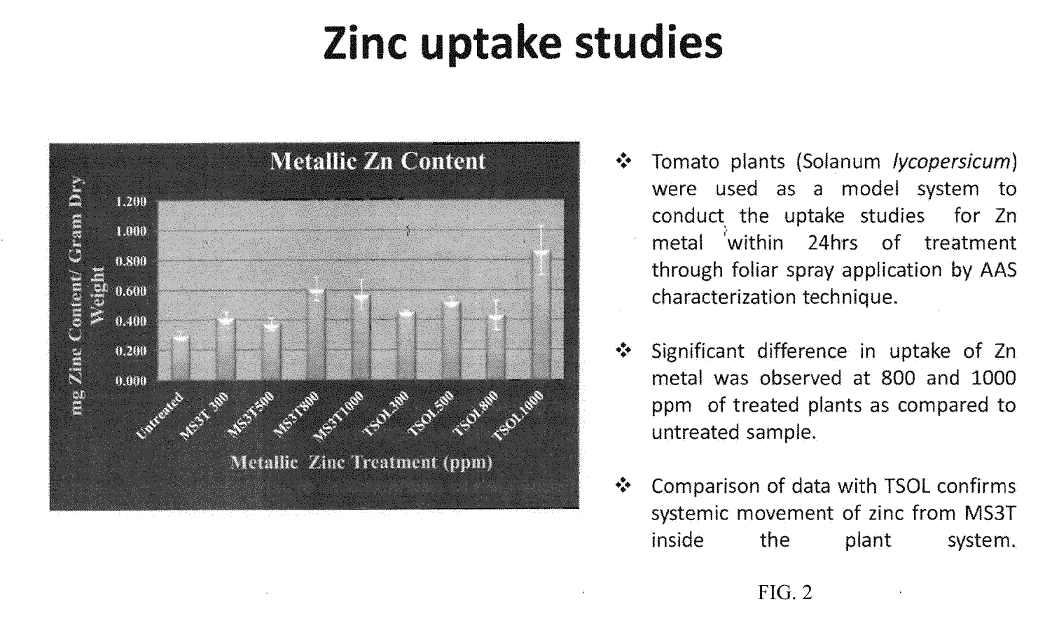

FIG. 2 shows the results of zinc uptake studies comparing MS3T agrichemical compositions and TSOL agrichemical compositions. As is indicated on FIG. 2, collected data indicates systemic movement of zinc from MS3T agrichemical compositions and TSOL agrichemical compositions into plant systems.

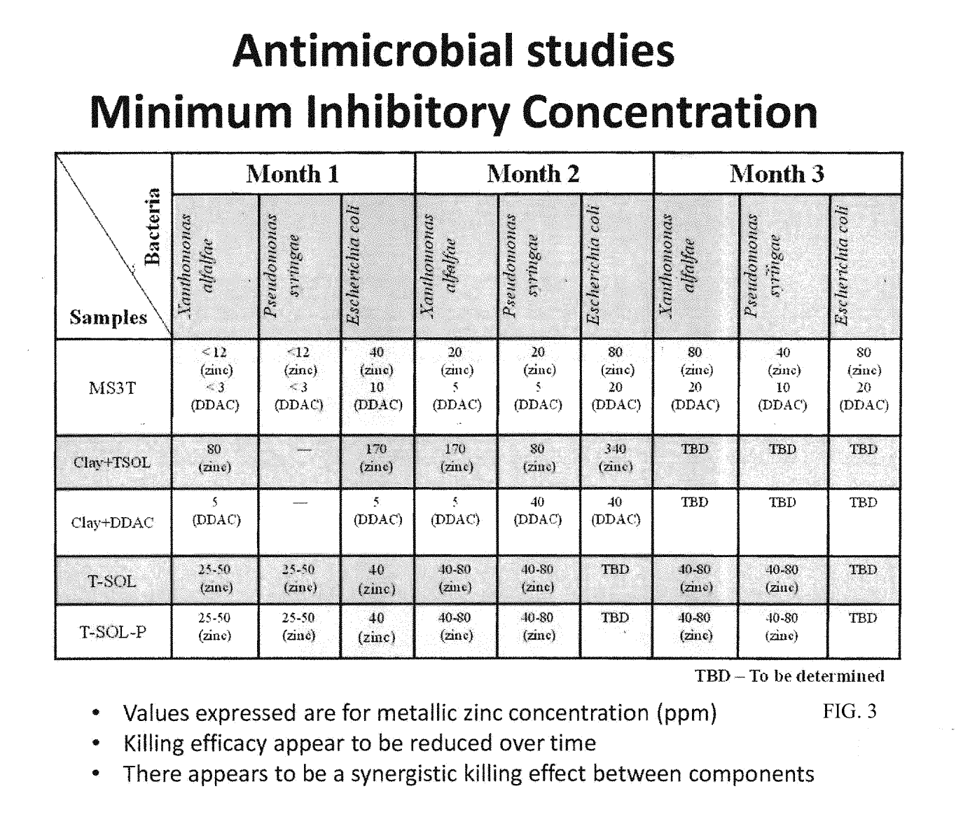

FIG. 3 shows the results of antimicrobial studies comparing results for MS3T agrichemical compositions and TSOL agrichemical composition antimicrobial efficacy. As is indicated in FIG. 3, there appears to be a synergistic effect between components of an MS3T agrichemical composition in accordance with the embodiments.

Rain-fastness studies for MS3T agrichemical compositions were undertaken to ascertain effect of rain on the agrichemical compositions previously applied to a plant leaf surface. Studies were conducted using 25 days-old Florida 91, a heat-tolerant hybrid Heirloom Tomato (Solanum lycopersicum), a model plant was purchased from a local Home Depot. These plants were sprayed with the MS3T and TSOL agrichemical compositions in triplicates for each sample. Each composition was sprayed at metallic zinc concentrations of 800 ug/mL and kept for 24 hour post spray application. A set of control plant was also observed with DI water in triplicates for the comparison of results. Formulations were sprayed on plants until run-off and approximately 200 mL of spray volume/plant was required to completely cover the entire plant. After 24 hours plants were subjected to simulated rain where water is applied to the plants by rate of 80 gallon per hour for two minutes. Simulated rain was repeated after 24 hr and set of plants separated after one, two, three and four wash. After this plant were cleaned and dried in the oven for 3 days at 50 C. Dried plants were grinded and digested in aqua regia for AAS

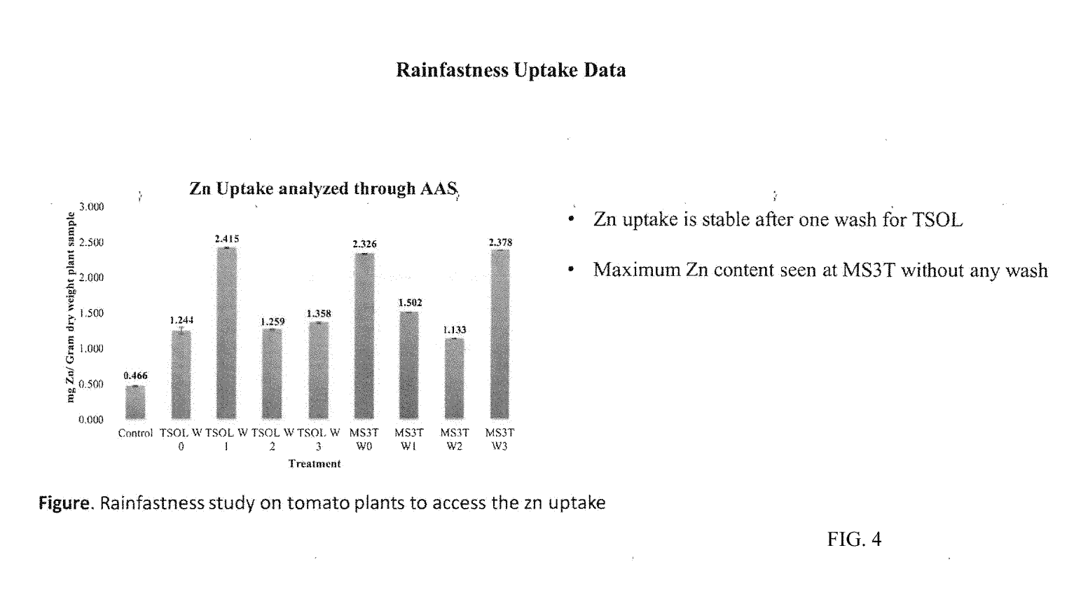

FIG. 4 shows the results of rain-fastness studies. As indicated in FIG. 4 zinc uptake is stable for one wash cycle for TSOL agrichemical composition and maximum zinc concentration is seen in MS3T agrichemical composition without any wash.

Applicant believes that the foregoing description supports the hypothesis that MS3T agrichemical composition may have superior and synergistic properties in comparison with TSOL agrichemical composition.

What is claimed is:

1. A composition comprising:
a clay material;
a metal chelate material; and
a quaternary ammonium material.

2. The composition of claim 1 wherein the metal chelate material is selected from the group consisting of a zinc chelate material and a manganese chelate material.

3. The composition of claim 1 wherein the metal chelate material is a zinc metal chelate material.

4. The composition of claim 1 wherein the composition further comprises a liquid carrier material.

5. The composition of claim 1 wherein the liquid carrier material comprises an aqueous liquid carrier material.

6. A method for preparing a composition comprising:
mixing together within a liquid carrier material:
a clay material;
a metal chelate material; and
a quaternary ammonium material.

7. A method for treating a plant comprising exposing the plant to a composition comprising:
a clay material;
a metal chelate material; and
a quaternary ammonium material
